(19) United States
(12) Patent Application Publication
(10) Pub. No.: US 2014/0209116 A1
(43) Pub. Date: Jul. 31, 2014

(54) DECORATIVE ELEMENT WITH BASE ELEMENT AND PINS ARRANGED THEREON WITH DECORATIVE OR ORNAMENTAL STONES, IN PARTICULAR PEARLS RESPECTIVELY ARRANGED THEREON

(71) Applicant: Peter Seibt, Kaufbeuren (DE)

(72) Inventor: Peter Seibt, Kaufbeuren (DE)

(21) Appl. No.: 14/241,305

(22) PCT Filed: Jun. 29, 2012
(86) PCT No.: PCT/EP2012/002740

§ 371 Date: Feb. 26, 2014

(30) Foreign Application Priority Data
Aug. 29, 2011 (DE) 20 2011 105 123.8
Mar. 6, 2012 (DE) 10 2012 004 637.5

(51) Int. Cl. F16B 17/00; A45D 8/24; A44C 25/00

(52) U.S. Cl. CPC F16B 17/00; A44C 25/008; A45D 8/24; A45D 2008/004
USPC 132/275; 63/20; 63/12; 63/15; 403/349

(57) ABSTRACT

A decorative element includes a base element configured as a support element with at least one of wire-formed and thread formed pins arranged thereon with at least one of ornamental elements, decorative elements and utility elements, wherein the support element comprises a multi-component formed element at least partially configured as at least one of a partial sphere and a partial rotational element that includes bore holes arranged over a circumference of the at least one of the sphere and the rotational element for receiving the pins, wherein one of the pins is inserted through a bore hole and fixed relative to the formed element.

### BACKGROUND

The invention relates to a decorative element according to the preamble of patent claim 1.

Decorative elements are used today in many manners, thus in particular commercially and also privately for various decorative purposes. Thus, it is known in particular for Christmas stars and similar to attach wire pins through solder joints on a star formed base element, wherein pearls or similar decorative stones are lined up on the wire pins. This yields an individually configurable decorative element which can be used in many ways for various applications.

It is the object of the invention to provide a decorative element which facilitates variability and simultaneously also facilitates stable anchoring of the pins or threads supporting the pearls.

Furthermore, the decorative element shall also provide a good optically pleasing design or appearance and be suitable for many applications through its variability.

### SUMMARY OF THE INVENTION

According to the invention a decorative element is provided with a base element configured as a support element with a number of wire-formed or thread-formed pins or also one or plural endless threads or wires for receiving ornamental elements or decorative elements, wherein the support element is configured in plural components, preferably in two components and thus configured from formed elements which are at least partially provided as a partial spherical elements or as partial rotational elements.

Bore holes are distributed over a circumference of the sphere or the circumference of the rotational element, thus in particular in longitudinal rows which are preferably arranged parallel to one another. The bore holes are provided for receiving pins. Thus, the formed elements can be spherical shells or flat shell formed elements so that for example a sphere can be formed when connecting two spherical shells, however a semi spherical element is generated when connecting a spherical shell with a flat shell with a level base as a placement surface, wherein the semi spherical element forms a semi sphere and can be placed on a horizontal surface.

Through the multi-component configuration of the element, in particular the two-shell configuration, a disengageable connection is feasible in a simple manner. This is useful in particular for a ball-formed element, in particular configured as a hollow element which is formed from two spherical shells or similar. These can be connected in a simple manner through a plug-in connection, a threaded connection or a bayonet closure. Also a threaded connection is advantageous, wherein the threaded connection is provided in sections over the entire circumference of the spherical shells. The multi-component arrangement and the disengageable configuration also increase variability because the formed element can be opened any time and the pins can be replaced or rearranged and attached, thus with the same length or with a different length. Thus, the pins or threads are run from the outside or the inside through bore holes that are distributed over the circumference of the ball shells and are preferably attached on the inside of the sphere through a pin button, a fold-over or a knot or a T-formed plug-in connection. Subsequently, the pearls can be lined up in any manner from the outside. At the free pin- or thread-end, the pearls are fixated through a knot, a fold, a ring or a thickening which is provided e.g. through upsetting. Optionally, in particular for a knotting of the threads or a fold-over of the pins for attachment at the inside of the sphere, the pearls can also be previously lined up on the pins or threads, thereafter the pins or threads are run from the outside through the bore hole and are then attached on the inside. In case the pin already has an attachment button at one end, running the pin through is performed from the inside of the sphere to the outside and subsequently the pearls or similar ornamental stones are threaded up from the outside.

In case of flexible threads made from plastic material the threads or plastic pins are stiffened by the threaded-on pearls which are closely adjacent to one another, so that the threads extend more or less in a straight line from the spherical shell in outward direction.

Instead of a wire pin or a thread also an endless thread can be used or also plural endless threads. In case of an endless thread the endless thread is inserted through a bore hole and attached therein as usual, thus through bending the wire over or through an applied crimping bead. On the section of the endless wire protruding outward beyond the spherical shell suitable decorative elements can be strung up. The protruding endless thread can then be bent into a loop. Optionally the free end can also be run inward through another bore hole and can thus be run outward through another bore hole forming additional loops and arranging decorative elements in rows. Also this yields broad variability.

In a particularly advantageous embodiment of the invention one of the spherical shells has a greater spherical section than the other shell, wherein the dividing plane of both spherical shells represents a secant plane through a sphere. When both spherical shells are connected with one another through a plug connector, thus a plug protrusion that can be integrally formed at one of the spherical shells, the spherical shells complement one another in a flush manner to form a spherical element. This embodiment yields the option that a row of bore holes with offset bore holes extends in a center of the sphere, this means along a central plane through the sphere which extends through the center of the sphere. This yields an appealing appearance with a center row of bore holes, wherein the other rows of bore holes are arranged parallel thereto. Thus, it is useful when the bore holes of adjacent rows of bore holes are offset relative to one another and thus respectively preferably centered with the bore holes of an adjacent row.

A plurality of bore holes is provided distributed over the ball or the spherical shell(s), wherein preferably each bore hole receives a pin, so that a large number of pins can be arranged distributed over the sphere or the spherical shell. When the pearls are then lined up on the pins or threads this yields a very decorative appearance. It is appreciated that pearls with different sizes and colors can be threaded onto the pins or threads in any manner.

In an advantageous embodiment of the invention, the two spherical shells have different sizes, wherein it is not excluded that both spherical shells are also as identically sized halves. In that both spherical shells are divided into halves with unequal sizes this yields a respective displacement of the connection seam or joint of the connection from the central plane of the sphere, wherein in a simple manner, also a row of bore holes and thus respective pins or threads for lining up the pearls in the central plane of the sphere, this means centered exactly about the center axis, can be provided. The other rows of bore holes are then arranged in parallel to the central plane defined by the center row of bore holes, in particular arranged in an identical manner so that an even structure of the pins or threads and of the pearls arranged thereon is provided about the sphere. In the context of a uniform structure of this type, the bore holes are arranged for each series of bore holes with uniform circumferential distance. The bore holes of adjacent rows of bore holes can then be aligned offset from these bore holes or identical with these bore holes. Thus, it is helpful when adjacent rows of bore holes are arranged concentric with one another, which however is not mandatory.

Preferably, the size of the sphere is in a diameter range of 1 to 10 cm, in particular 2 to 5 cm. Thus, bore holes with a number between 10 and 100, preferably 20 to 72, particularly preferably 34 to 60, can be provided per sphere.

The pins are advantageously provided in the form of wires, in particular metal wires, in particular steel wires. The pins, however, can also be made from plastic material. Instead of stiff pins, also textile or plastic threads can be used, in particular nylon threads. Since the threads or pins are attached at the spherical shell, a self-acting stiffening of the threads is provided when the pearls are tightly spaced, so that the threads remain raised. Thus, it is advantageous overall when the pins or threads are arranged perpendicular to a plane contacting the respective bore hole in a tangential manner.

The spherical shells themselves can be made from metal, in particular brass, or from plastic material. Furthermore, spherical shells can be colored or coated, in particular with gold-, silver- or copper-colored layer. The pins can either extend with identical length from the spherical shell in outward direction or with different lengths, wherein the pin size is in a range of 1 to 7 cm, preferably 1 to 5 cm, particularly preferably between 1.5 to 3.5 cm. The same applies for the thread length respectively computed extending from the outer spherical surface.

The attachment of the pins is provided through a pinhead in the interior of the spherical shell, whose dimensions are larger than the dimensions of the bore hole. Alternatively, the pin can also be bent or upset in order to attach the pin at the spherical shell. In case of threads made from textile material or plastic material, the attachment is provided through knots or in that the threads have a T-formed head. The thread can then be threaded in through the T-piece. The T-head then fixates the thread in outward direction so that pearls are applied from the outside and the pearls can then be fixated through a knot connection.

In case of a flat shell that is attachable at a spherical shell and that has a flat base various functional elements can be attached thereon which increases variability. Particularly suitable are an ear clip, a broach pin, an ear pin, hair clips, hair clamps, finger rings, hat pins, and similar. At spherical shells or at the flat shells also animal figures or Christmas angels can be attached, so that indefinite variability is provided. The invention is particularly suitable for an arts and crafts system, wherein the spherical shells and a flat shell are provided as base elements, which are connectable with one another, wherein the spherical shells are configured with respective bore holes for receiving pins, threads, or endless threads or endless wires. The flat shell can be used as stand element or for attaching functional elements.

### BRIEF DESCRIPTION OF THE DRAWINGS

Subsequently embodiments of the invention are described with reference to the drawing, wherein:

FIG. 1 illustrates a perspective schematic view of a sphere formed from two spherical shells;

FIG. 2 illustrates a schematic partial view for illustrating a pin;

FIG. 3 illustrates an analogous alternative view of FIG. 1; and

FIG. 4 illustrates an embodiment of a thread with a T-formed head piece for attachment.

FIG. 5 illustrates another embodiment of a spherical decorative element according to the invention;

FIG. 6 illustrates a view of the sphere of FIG. 5 in an open position of both spherical shells;

FIG. 7 illustrates another embodiment of a spherical shell configured as a suspended element;

FIG. 8 illustrates another embodiment of a spherical shell configured as a standing decorative element or a table decorative element;

FIG. 9 illustrates a side view of another embodiment according to the invention;

FIG. 10 illustrates another embodiment of the invention configured as a napkin ring or table card holder;

FIG. 11 illustrates another embodiment according to the invention configured as an ear clip;

FIG. 12 illustrates another embodiment of a pin.

### DETAILED DESCRIPTION OF THE PREFERRED EMBODIMENTS

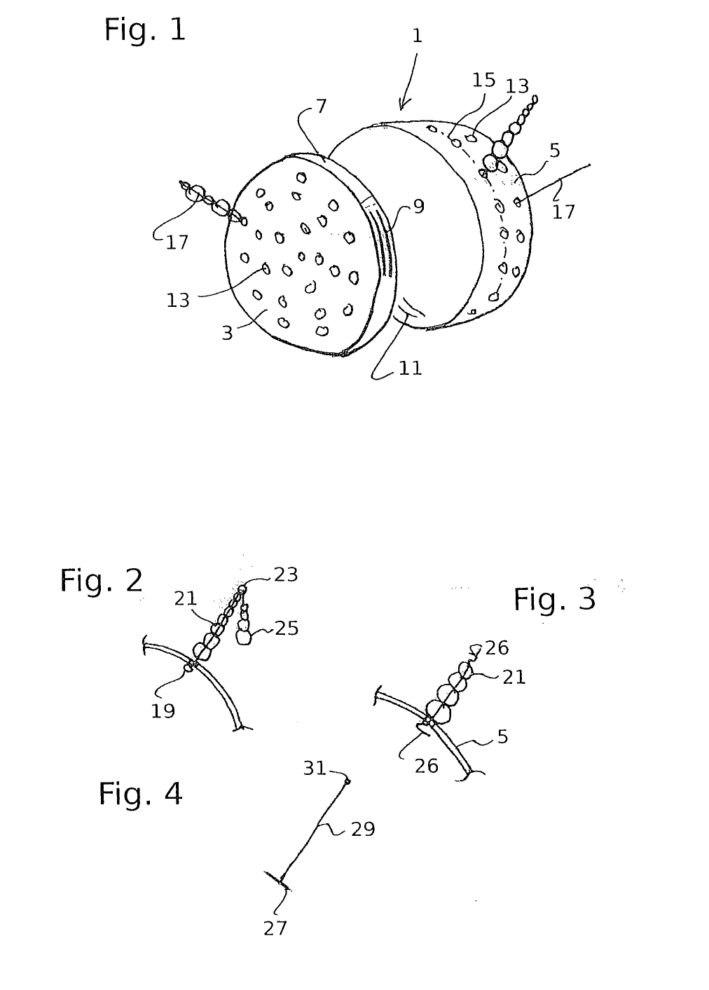

FIG. 1 illustrates a spherical element 1 configured as a sphere which is formed from two shells 3 and 5. Thus, the shell 3 is configured as a ball-formed scraper is configured slightly smaller than the spherical shell 5 also configured as a ball-formed scraper. The two shells 3 and 5 can either be connected with one another through an insertable connection or a threaded connection. For illustration purposes, FIG. 1 illustrates a plug-in socket 7 which is sized smaller relative to the rest of the spherical shell 3, wherein the spherical shell 3 is insertable into the spherical shell 5 through the plug-in socket. Therefore, the plug-in connection is a fitted connection which is fixated, however, also disengageable under tension. Alternatively, and this is schematically illustrated in FIG. 1, the connection of both shells 3 and 5 can be provided through a threaded connection. Thus, one or plural threads can be provided over the entire circumference of the socket 7 which is schematically indicated by the reference numeral 9. Respective thread turns or a respective thread is then also provided in the edge portion of the spherical shell 5 as indicated at 11. Instead of a circumferential thread turn, thread turns can also be provided in sections as apparent from FIG. 1 for both spherical shells 3 and 5. Alternatively the interconnection of both spherical shells can also be provided through one or plural bayonet closures which are not illustrated.

It is apparent that each spherical shell is provided with a plurality of bore holes 13 which extend through the spherical shell. Thus, it is helpful that a row of bore holes is provided in the central plane of the sphere which is designated as 15. The row of bore holes is also illustrated in dashed lines which only serve illustration purposes. In the illustrated embodiment, additional rows of bore holes are provided which are configured at a distance from the row of bore holes 15 that are configured centered in the center plane and which also include a number of bore holes 13 that are preferably arranged at uniform distances from another. However, it is not mandatory that the bore holes are arranged at uniform distances from one another; however an even structure is generated for an arrangement with even distances. Optionally, the bore holes of adjacent rows of bore holes can also be arranged offset from one another.

Through these bore holes 13, as described best with reference to FIGS. 2 and 3, a pin 17 is inserted. The pin 17 illustrated in FIG. 2 includes a thickened head 19 at its inner end, wherein the thickened head has at least one dimension which is greater than the diameter of the associated bore hole 13. Thus, the pin 17 is inserted from the inside to the outside through the bore hole 13 until the pinhead 19 contacts the inner surface of the spherical shell. Then, pearls 21 are lined up from the outside which can have identical sizes or completely different sizes and can have identical or different shapes. After the lineup of the pearls 21, a fixation is provided at the protruding free-end of the pin 17 through forming an eyelet, wherein the eyelet 23 is apparent from FIG. 2 and can also be used as a hanger for another row of pearls 25. For better illustration, the pearls 21 are represented as transparent pearls so that the pin 17 is visible. This also applies for FIGS. 1, 2 and 3.

In the embodiment, according to FIG. 3, mounting the pin is provided at the interior of the spherical shell through folding the pin over, wherein the fold-over is designated as 25. Fixating the lined up pearls 21 is in turn provided through a fold-over 25 at the free end of the pin. The pin is configured as a metal wire, in particular as a steel pin.

FIG. 4 alternatively illustrates a plastic material thread made from nylon which is configured with a T-piece 27 for attachment at its lower end for insertion into a bore hole and attachment of the thread at the spherical shell. Subsequently, the pearls not illustrated in FIG. 4, are lined up and a fixation of the non-illustrated pearls is provided at the thread 29 through a knot 31.

The variability of the decorative element is rather large since the pins do not have to be provided in each bore hole, the pins or threads can be configured with different lengths and also a different number of pearls with different size and shape can be provided which is at the discretion of the user of the decorative element. It is helpful that the decorative element is configured in a very simple manner, can be opened and replaced with new pins or threads any time so that the design can be changed at will. The decorative element is suited in particular for arts and crafts and is therefore highly suitable in particular for school applications. The decorative element in do it yourself construction also appeals to all age groups and is also suitable for arts and crafts applications in assisted living facilities. It is advantageous that the same spherical element can be used for different decorative arrangements. This is caused by high variability, the simple assembly of the pins and threads and the simple lineup of the pearls and the simple opening and closing of the spherical element. A spherical element in the context of this application means that the element does not have to be a strictly geometrical sphere, though the sphere actually has exactly spherical shape in a preferred embodiment.

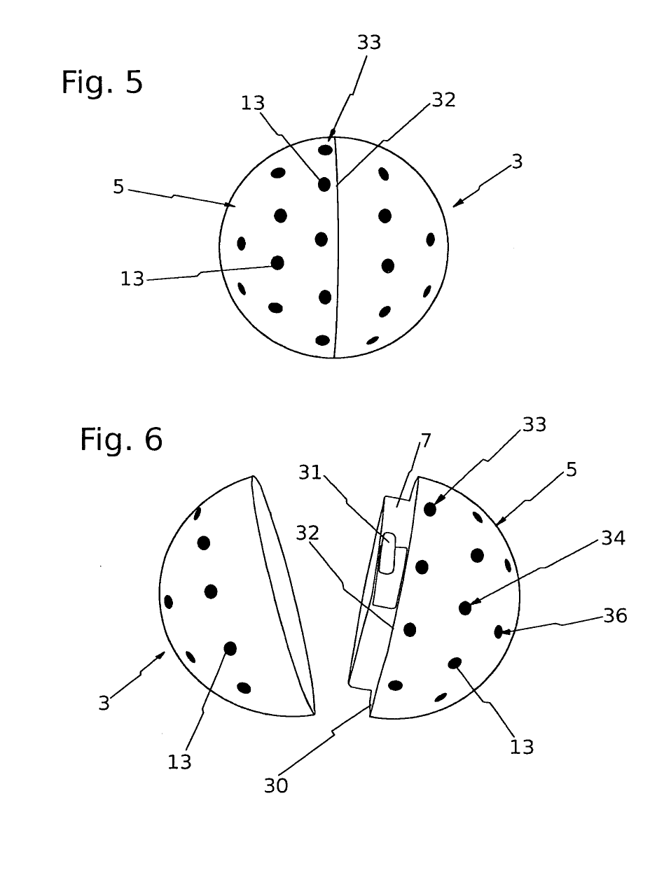

The embodiment illustrated in FIGS. 5 and 6 is configured from two spherical shells 3, 5. As illustrated in FIG. 6 one of the spherical shells, herein the spherical shell 5 is configured with a larger sphere section than the other spherical shell 3 according to FIG. 6. The spherical shell 5 like the embodiment according to FIG. 1 has a plug in section 7 which is configured offset inward through a circumferential annular shoulder 30 relative to the larger sphere section. This plug in section represents a plug connector through which the spherical shell 5 can be attached at the other opposite spherical shell 3. The spherical shell 3 certainly includes a respective receiving mechanism corresponding to the plug in recess 7, thus as already described in a context with the embodiment according to FIG. 1.

As apparent from FIG. 6 for the right spherical shell 5 a thread section 31 is arranged on the plug in section 7, wherein a second respective thread section is provided on an opposite side of the plug in section 7 which, however, is not evident from the drawing figure. Thus, two opposite thread sections 31 are provided for the illustrated embodiment at the plug in section 7. Respective threaded grooves which correspond with these thread sections are configured at the opposite spherical shell 3. The invention is certainly not limited to two thread sections which are only exemplary. Three or four or more thread sections can be distributed over the circumference which is eventually also a function of the size of the decorative element.

Both spherical shells form a sphere in combination along a dividing plane 32 or a dividing line 32 which is eventually formed by the annular shoulder 30. The dividing plane 32 represents a secant plane through the spherical element, this means that the dividing plane or the circumferential edges of the spherical shells which contact one another when assembling the shells are generated by an intersection of the sphere with a plane which goes through the sphere but not through the center of the sphere so that both spherical shells complement one another to form a sphere after connecting through the plug in section 7 and the thread sections.

This embodiment has the option that a row 33 with bore holes is on a central plane after connecting both spherical shells, wherein the central plane intersects with the spherical element and extends through the center of the sphere as clearly apparent from FIG. 5. This means the dividing line 32 is offset to the right relative to a central plane through the sphere center so that the row 33 with offset bore holes 13 can be arranged along an intersection plane with the sphere which is formed by the central plane through the center of the sphere.

As apparent from FIGS. 5 and 6 additional rows of bore holes 34 and 36 are arranged on this sphere and thus in an arrangement that is parallel to the row of bore holes 33 and also to the row of bore holes of the opposite shell. The rows of bore holes 13 of adjacent rows of bore holes are thus offset from one another with parallel centers as apparent from the view of the right spherical shell in FIG. 6. This embodiment is useful but not the only one. Various embodiments are feasible.

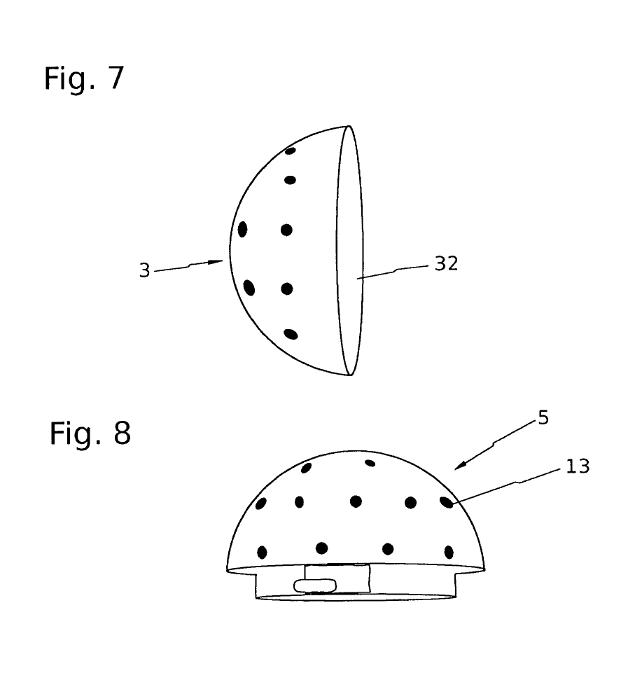

FIG. 7 illustrates the spherical shell which is illustrated in FIG. 6 on the left side and which can be used as a suspended decorative element. For this purpose the spherical shell 3 can be provided at the secant dividing line 32 for example with an inward oriented fold over which forms a suspension eyelet through which the spherical shell 3 can be suspended at a wall.

The embodiment according to FIG. 8 uses the spherical shell 5 that is apparent from FIG. 6 as a standard element so that FIGS. 7 and 8 illustrate that the individual spherical shells can also be used as separately standing decorative elements or suspended decorative elements.

It is appreciated that also the embodiment according to these figures has pins or threads run through the bore hole 13 and the pins or threads are attached at a spherical shell as described already with reference to the embodiment according to FIGS. 1-4.

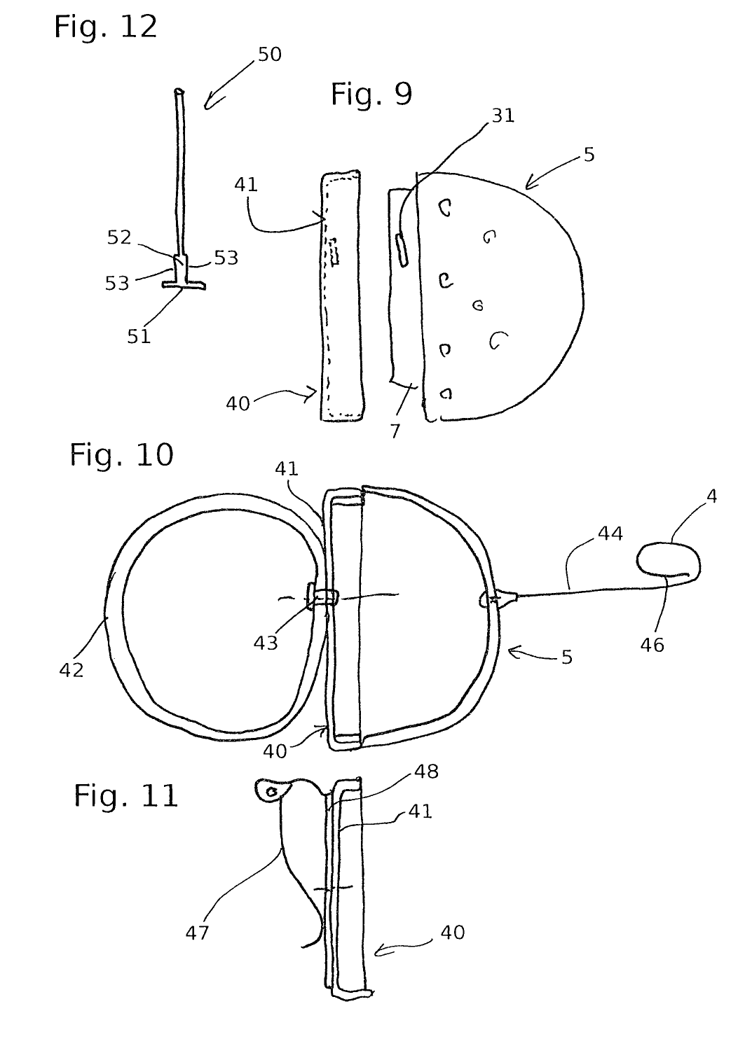

FIG. 9 illustrates another embodiment in which a spherical shell 5, thus the spherical shell illustrated in FIGS. 5 and 6 that is provided with a plug in section 7 is used. This spherical shell can be analogously connected with a shell element 40 with a flat base element 41. Thus, FIG. 9 illustrates the threaded groove in dashed lines on the left side which threaded groove interacts with the thread section 31 formed on the plug in section 7 for attaching both elements at one another. Connecting the shell formed component with the spherical shell 5 yields a decorative element which can be used on a horizontal surface as standing decorative element. This yields a semi sphere instead of a total sphere according to the illustration in FIG. 1.

FIG. 10 illustrates variations of the embodiment according to FIG. 9 in turn in a schematic view. Thus, a napkin ring 42 is attached at a base 41 of the shell 40 and thus in particular through a threaded bolt 43. On the opposite side at the spherical shell 5 a pin 44 is run through the top most bore hole and attached at the spherical shell wherein the pin is bent into a spiral shape 46 in its upper most portion 45, wherein the spiral shape 46 is used as a receiving element for table cards or name cards which are insertable therein. Alternatively, however, also other configurations are feasible in that for example the spherical shell 5 is integrally configured with the shell 40 as a receiver for a candle holder, wherein a candle holder only has to be attached at the spherical shell. For this purpose only a T-pin has to be inserted through the center bore hole in an upper portion of the spherical shell where a candle holder is then attached in a suitable manner. Thus, a pin run through at an upper end of the spherical shell can also be used as an insertion pin for inserting a candle, so that dedicated candle holders are not required. The remaining bore holes can then be used for receiving various decorative elements through the inserted pins.

In the embodiment according to FIG. 11 a known ear clip 47 is attached at the base 41 of the shell 40, thus through a small plate 48 which is for example glued together with the base 41 of the shell 40 or can be attached in another suitable manner, thus screwed together. The shell 40 is then connected with a spherical shell 5 so that a piece of ear jewelry is provided which can be configured in any manner. Instead of an ear clip also ear plugs or hair clips, finger rings, hat pins and similar can be attached which shows the variability of the system.

As stated regarding the embodiment according to FIG. 11 instead of a hair clip also another functional element can be attached, in particular a broach pin can be soldered on or glued on so that the decorative element can be pinned to a garment. In the embodiment according to

FIG. 11, the illustrated small plate 48 can also be attached at the shell 40 through a central threaded connection as indicated in FIG. 11. Thus, different attachment options are conceivable that are within the skill of a person skilled in the art.

Instead of pins or threads that are run through the bore holes also commercially available endless wires can be used which are run from an inside through one of the bore holes, wherein the beginning of the wire is fixated through annular bending or through attachment of a so called crimp bead. The endless wire that is run through is then formed in a loop or differently and can be decorated with decorative elements. Thus, the endless wire can also be run through other bore holes and can be pulled out again at another location, wherein in turn loop formation is feasible and decorative elements can be put on the wire. This yields a plurality of different decorative and design options.

For example the spherical shells can also be used for curtain decorations. For a curtain tie down whose ends are often provided with commercially available tassels as a completion the ends can also be decorated with the two spherical halves. Thus small magnets provided with small individual bore holes can be attached in each of the half spheres in the cavities of the two half spheres. The half spheres in turn are attached at both ends of the curtain tie downs and are assembled through the magnetic effect until a voluntarily provided separation occurs and can thus be used as decorative curtain tie downs.

The spherical shells or spherical elements with the pins, threads or endless wires can also be used in combination with plant assemblies. For example a plant assembly can be attached through pins at an approximately central portion of the spherical shell, whereas one or plural endless wires can be run through the adjacent bore holes that do not have to be used for the plant assembly and wherein a decorative effect is achieved through forming loops and stringing up decorative elements on the endless wires wherein the decorative effect adds to the appearance of the plant assembly.

FIG. 12 illustrates an embodiment of a wire pin 50 with a circular cross section which includes a T formed attachment element at its lower end. Above the T-head a flat rectangular element 52 is produced through flattening the pin with circular cross section wherein the flat element has sharp edges 53 on both sides. The flat element with edges thus advantageously extends over a length which corresponds approximately to the thickness of the spherical shell. This can be for example a length of 4 mm. This yields sharp cutting edges on both sides of the flat element. This has the effect that the pin after loosely running the circular pin through the bore hole the pin is effectively anchored in the bore hole through the flat element with edges so that any movement of the pin attached in the spherical shell can be avoided in a simple manner. Thus, the diameter of the wire pin 50 is adapted to the diameters of the bore hole in the spherical shells so that the desired attachment in the bore hole is achieved through a pressed flat element 42 with edges. This yields a very simple and secure permanent fixation of the wire pins in the spherical shell.

1-20. (canceled)

21. A decorative element with a base element configured as a support element with at least one of wire-formed pins and thread-formed pins arranged thereon with at least one of ornamental elements, decorative elements and utility elements, arranged thereon, and wherein the support element comprises a multi-component formed element at least partially configured as at least one of a partial sphere and a partial rotational element that includes bore holes arranged over a circumference of the at least one of the sphere or the rotational element for receiving the pins, wherein one of the pins of the at least one of the wire-formed pins and the thread-formed pins is inserted through the bore hole and fixed relative to the formed element.

22. The decorative element according to claim 21, wherein the at least one of the ornamental elements, the decorative elements, and the utility elements includes at least one of jewelry stones and decorative stone.

23. The decorative element, according to claim 22, wherein the jewelry stones includes pearls.

24. The decorative element, according to claim 21, wherein the formed element is configured as a hollow element and configured from two spherical shells which are connected with one another in a disengageable manner, through at least one a plug-in connection, a threaded connection and bayonet connection.

25. The decorative element according to claim 21, wherein the two spherical shells are different sizes.

26. The decorative element according to claim 21, wherein one of the spherical shells has a greater spherical section than the other spherical shell, and wherein the two spherical shells in connected position form a spherical element, wherein the spherical or shells are respectively defined through a common secant plane which forms a dividing plane of both elements so that the two spherical shells can be assembled flush along the dividing plane to form a spherical element.

27. The decorative element according to claim 26, wherein one of the spherical shells is configured with a plug in section that forms a plug connector.

28. The decorative element according to claim 27, wherein the spherical shell provided with the plug connector is connectable with at least one of another spherical shell to form a spherical form element and a shell shaped form element that includes a flat base, wherein thread sections are arranged on a plug in a section which thread sections are distributed over the circumference, wherein the thread sections interact with respective complementary grooves within the other form element, and wherein two thread sections are provided opposite to one another on the plug in section.

29. The decorative element according to claim 28, wherein at least one partial spherical element and partial rotational element includes rows of bore holes, wherein each row of bore holes includes bore holes that are arranged at a distance from one another which distance is identical for all the bore holes.

30. The decorative element according to claim 29, wherein the rows of bore holes on a spherical form element are arranged on the spherical shells along secant planes that are parallel to one another, wherein a central row of bore holes defines a plane which extends through a center of the sphere and parallel to the secant planes, and wherein the plug in section preferably adjoins the formed element.

31. The decorative element according to claim 30, wherein a central row of bore holes defines a plane which extends through the center of the sphere and parallel to the secant planes, and wherein the plug in section adjoins the formed element.

32. The decorative element according to claim 21, wherein each sphere includes between about 10 to about 100 bore holes.

33. The decorative element according to claim 32, wherein each sphere includes between 20 and 72 bore holes.

34. The decorative element according to claim 33, wherein each sphere includes between 34 and 72 bore holes.

35. The decorative element according to claim 21, wherein the at least one of the wire-formed pins and the thread-formed pins comprise a metal wire, steel, a plastic material of a textile, a plastic material threads, and a Nylon, and wherein the pins are attached within the spherical shells by at least one of a bending, a knot, a head and a T-plug head.

36. The decorative element according to claim 21, wherein the at least one of the wire-formed or thread-formed pins are attached within the spherical shells by at least one of folding, knotting, forming a head at the inner pin end, forming a T-plug head, and wherein the spherical shells are comprise at least one of metal and a plastic material.

37. The decorative element according to claim 21, wherein a flat shell shaped element with a flat base configured as a placement surface is adapted to connect with a spherical shell.

38. The decorative element according to claim 37, further including at least one of an ear clip, a napkin ring, an ear pin, a hair clip, a hair clamp, a finger ring, a hat pin, and a broach pin are adapted to attach at the base of the flat shell via at least one of gluing, a threaded connection, a pin connection, soldering and a form locking connection.

39. The decorative element according to claim 21, wherein the pins are provided with circular cross sections and include a T-formed end at which a flat pin element with sharp cutting edges on both sides adjoins.

40. The decorative element according to claim 21, wherein the multi-component formed element includes two components.
